(19) United States
(12) Patent Application Publication
(10) Pub. No.: US 2011/0177299 A1
(43) Pub. Date: Jul. 21, 2011

(54) IMPROVEMENTS IN CORRUGATING ROLLERS

(75) Inventor: Patrick Petrus Antonius Maria Van Berlo, Cambridge (NZ)

(73) Assignee: CORCEL IP LIMITED, Hamilton (NZ)

(21) Appl. No.: 12/999,618

(22) PCT Filed: Jun. 25, 2009
(86) PCT No.: PCT/NZ2009/000121

§ 371 Date: Feb. 25, 2011

(30) Foreign Application Priority Data
Jun. 25, 2008 (NZ) 569425

(51) Int. Cl. B32B 3/28; B29C 53/22

(52) U.S. Cl. 428/182; 425/388; 264/505

(57) ABSTRACT

The present invention relates to a corrugating roller configured with at least two opposing sides, and a corrugated contact surface about an outer face of the roller, the roller characterized in that the roller includes a passageway from one opposing side to another, the passageway configured to allow fluid flow from the contact surface of the roller to at least one side of the roller, according to a further aspect of the invention the corrugated outer surface of the roller is effectively formed by a plurality of discs located about a common axis and each separated from one another by a radial space.

### TECHNICAL FIELD

The present invention relates to improvements in corrugating rollers. The invention has particular application to corrugating of cardboard or paperboard.

### BACKGROUND ART

Single faced corrugated paper board is very well known and is used extensively in industry, especially in packaging where it is used as protective padding and wrapping. It is also used as a basic component in the production of many structural objects such as boxes, panels, pallets etc.

Sheets of single faced corrugated paper board can be bonded together to form multilayer corrugated paper boards of various thickness and strength. One reason for the wide use of such paper board is its relatively light weight, rigidity and strength.

Single faced corrugated paper board is made by bonding a fluted sheet, typically of Kraft paper, onto a liner sheet. The liner sheet is also typically Kraft paper although other materials may be used.

In a typical conventional machine for producing single faced fluted paper board, the fluted sheet is formed by passing paper that is unwound from a paper reel to a pair of corrugating rollers.

The two rollers are arranged such that there is an inter-meshing of the teeth at the periphery of each roller. The paper is fed between the teeth of the rollers which forces the paper into flutes with the shape of the teeth of the rollers.

Prior to the fluted sheet passing through the corrugating rollers, it is held in contact with the teeth on the periphery of one of the corrugating rollers. Only the tension applied to the paper by the paper reel is holding the sheet of paper in place on this roller.

Once the sheet has passed through the inter-meshing teeth of the corrugating rollers, adhesive is applied to the fluted surface of the paper, and a liner is added. A pressure roller applies a force to the liner to encourage the bonding of the two layers of paper.

To ensure the effectiveness of the corrugating mechanism, it is important to ensure the paper remains in position as it passes over the corrugating rollers. If the paper does not remain in position, the paper slackens, and the corrugations formed become imprecise and not adequately defined.

Typically, during this transition period, a pressure differential at the corrugating surface of the rollers is created, holding the paper in place as it passes between the corrugating rollers.

In the prior art, the vacuum systems used to ensure the paper is adequately held in position against the corrugating rollers have limited effectiveness.

Existing corrugating rollers have small grooves which are arranged around the length or circumference of the roller. These grooves are complex to machine when manufacturing the corrugating rollers, adding greatly to the cost of manufacture.

The area surrounding the rollers is constructed such as to mimic a closed environment to more effectively create the vacuum. For example, in some prior art systems, a box-like surround is placed opposing the rollers. However, despite this, air is able to be sucked into the box around its perimeter, which reduces the vacuum effect generated by the grooves.

At one end of the box surround, a vacuum source such as a vacuum pump is mounted. This draws air from the grooves about the corrugating rollers creating a pressure differential at the corrugating surface of the rollers.

Paper or cardboard passing over the grooves is drawn towards the grooves, thus holding the paper or cardboard against the surface of the rollers.

Another problem with existing corrugating rollers is their size and weight, and the subsequent impact on the chassis of the corrugating machine.

The formation of corrugated cardboard requires a considerable amount of heat to cure the adhesive used to bond the liner to the fluted sheet. This is necessary to reduce the time which is required to maintain the contact between the fluted sheet and the liner to allow formation of a sufficient bond between these two mediums. This time can be several seconds or longer at normal room temperatures and pressures. However, by raising the temperature during the bonding process, this time can be reduced.

Typically starch based adhesive is employed—which needs at least 150 to 200° C. of heat to initiate gelling.

High pressure steam is commonly used to heat the cylinders over which the fluted paper and liner paper move, raising the temperature of the paper. Typical operating temperatures for the corrugating rollers can be around 200° C.

To reduce the contact time between the pressure roller and corrugating roller (which holds the fluted sheet), high pressures are generally required to significantly speed up the bonding process.

Therefore, although the use of heat and high pressures can shorten the time required to form a bond between the fluted sheet and the liner, and therefore allow high through-put, it does introduce a number of engineering issues which significantly increase the cost of the machinery and the operating costs for the process.

The corrugating rollers need to be engineered to withstand both the significant heat and pressures to which they are exposed. Inevitability this is achieved through the select use of appropriate materials.

Typically, corrugating rollers in the prior art are manufactured from hardened alloy steel. It is common to coat the rollers with chrome as a further protective measure. This ensures that the corrugating rollers are sufficiently robust to withstand their harsh working environment.

However, such robust construction has an impact on the overall cost of the corrugating machine, as alloy steel corrugating rollers are particularly expensive to produce. This is even more so, when one factors in the machining required to create the grooves of the roller.

The manufacture from steel alloy also adds considerably to the weight of the rollers. This makes assembly and maintenance of the corrugating rollers very time consuming and labour intensive if the rollers need to be removed from the chassis of the corrugating machine.

The chassis of the overall corrugating machine also needs to be sufficiently engineered to bear the weight of the rollers. This adds to the cost of manufacturing corrugating machines.

There is a trend towards corrugating methods which do not involve substantial heat or pressure treatment. This is achieved using arrangements of belts to hold the material being corrugated in place as pressure is applied to the material. However, such methods are implemented using conventional corrugating rollers which incorporate the aforementioned disadvantages of cost and weight.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided a method of applying a vacuum to the outer surface of a corrugating roller characterised by the steps of:
a) providing a vacuum to an inner core region of the roller;
b) directing the vacuum from the core to the outer corrugated surface of the roller.

According to one aspect of the present invention, there is provided a corrugating roller, wherein the roller includes:

a corrugated contact surface about an outer face of the roller;
the roller characterised in that
the roller includes at least one passageway between opposing sides of the roller, and
the passageway is configured to allow fluid flow from the contact surface of the roller to the passageway through the roller.

According to another aspect of the present invention, there is provided a method of corrugating a planar sheet of material, using a roller which includes:
a corrugated contact surface about an outer face of the roller,
at least one passageway substantially from one opposing side of the roller to the other and
   wherein the passageway is configured to allow fluid flow from the contact surface of the roller to the passageway through the roller;
   the method being characterised by the steps of:
a) connecting a vacuum source to the end of the passageway(s) at the side(s) of the roller; and
b) passing a planar sheet of material onto the contact surface of the roller;
   wherein the vacuum source creates a pressure differential at the contact surface which maintains the material against the roller.

According to a further aspect of the present invention there is provided a composite corrugating roller which includes:
a corrugated outer surface;
   wherein the corrugated outer surface is effectively formed by a plurality of discs located about a common axis and each separated from one another by a radial space;
   wherein the discs are adapted to collectively form at least one passageway passing through the discs in a direction extending substantially parallel to the rotational axis of the roller and to which a vacuum can be applied;
   wherein the passageway is connected to the radial spaces so a vacuum can be imparted to the outer surface of the roller.

According to a corrugating roller which includes:
an inner core;
a corrugated outer surface;
   wherein the corrugated outer surface has a plurality of radially extending apertures distributed over its surface, and
   wherein the inner core of the roller is adapted to include at least one passageway passing through the core in a direction extending substantially parallel to the rotational axis of the roller and to which a vacuum can be applied,
   wherein the passageway is connected to the radially extending apertures so a vacuum can be imparted to the outer surface of the roller.

A roller should be understood to mean any cylindrical member with two opposing sides and a contact surface, capable of turning the contact surface.

The contact surface should be understood to mean the surface of the roller which contacts the planar material being rolled. The configuration of the contact surface may vary according to the requirements of the material being rolled.

In preferred embodiments of the present invention, the contact surface of the roller is configured to impart a corrugated surface to a sheet of paper or cardboard.

Reference throughout the remainder of this specification shall now be made to the rollers as being corrugating rollers for use with paper or cardboard, although persons skilled in the art will appreciate the present invention has other industrial applications.

A corrugating roller should be understood to mean a roller bearing teeth about its contact surface. Passing paper or cardboard between a pair of synchronised opposed corrugating rollers will impart a corrugated surface to the paper or cardboard.

The passageway should be understood to mean a passage running through the roller through which a fluid may pass. Persons skilled in the art will appreciate that the term “fluid” is not meant to be limited to liquids, and that gas may be passed through the passageway according to the requirements of the material being rolled, and the environment in which the material is being rolled.

In preferred embodiments of the present invention, the passageway is a conduit for air under the influence of a vacuum source.

The passageway is connected to the vacuum source. In preferred embodiments of the present invention, the vacuum source may be placed on or adjacent one or both sides of the roller. This is preferred, as the closer the vacuum source is to the corrugating rollers, the more effective the vacuum. In the prior art, the vacuum generating mechanism is mounted in a boxed area opposing the rollers.

In some embodiments of the present invention, a vacuum source may be provided for each passageway of the rollers.

In some embodiments of the present invention, the vacuum source is mounted directly to the side(s) of the roller.

The passageway has an entry or exit at the contact surface of the roller, and a corresponding entry or exit at a side of the roller, thus connecting the contact surface to the vacuum generating mechanism. For example, the passageway may be a hole drilled radially into the roller from the contact surface to meet with a hole drilled laterally through the roller from a side of the roller, the laterally drilled hole being ducted to a vacuum generating mechanism.

The vacuum generating mechanism may be any apparatus which generates a vacuum. In preferred embodiments of the present invention, the vacuum source is a high volume centrifugal vacuum pump, and shall be referred to as such throughout the remainder of the specification.

In preferred embodiments of the present invention, there is a composite roller is formed from a plurality of similar roller or discs mounted on an axle. A disc should be understood to have:

at least two opposing sides, and
a corrugated contact surface about an outer face of the disc where,
the disc includes a passageway from one opposing side to the other, and
the passageway is configured to allow fluid flow from the contact surface of the disc to at least one side of the disc.

In preferred embodiments of the present invention a disc may have a plurality of passageways.

It should be understood that when a plurality of discs are assembled on an axle to form a roller, there is effectively formed a continuous passageway through the roller.

In preferred embodiments of the present invention, the discs are placed on the axle such that spaces are formed between adjacent discs to allow fluid flow from the contact surface of the discs to the passageway through the rollers.

The formation of the spaces between adjacent discs may be achieved through the use of spacers between each disc. For example, the spacers may be one or more washers, the size of which vary according to the requirements of the material being rolled. In the present invention, the washers are very thin, to ensure maximum contact of the paper or cardboard with the teeth of the corrugating rollers.

In some embodiments of the present invention, the spacing may be achieved through the use of discs with protrusions extending laterally from a side of the disc, the protrusions contacting the side of the adjacent roller.

In these embodiments, the protrusions extend from the side of the disc surrounding the axle, although persons skilled in the art will appreciate that the protrusions may extend from other areas of the side of the disc depending on the requirements of the user, and the material from which the disc is made.

In preferred embodiments of the present invention each disc is approximately 30 mm wide, although persons skilled in the art will appreciate the width of a disc may vary according to the requirements for establishing a vacuum to hold a sheet of material against the contact surface.

The applicant has found that discs of this size are relatively straightforward to manufacture using either lasers, water jets or plasma cutters depending on the type of material used for the disc. Alternatively, a single master mould is all that is required to manufacture the discs from mouldable materials such as plastics. This makes it easier to allow for varying fluting profiles, as a master mould can be manufactured for each desired profile.

In preferred embodiments of the present invention, the width of the space between adjacent discs is no more than a few millimetres. The applicant has found that a width greater than 5 mm reduces the effectiveness of the rollers when being used for corrugating paper or cardboard.

The strength of the corrugated paper is compromised as there is little or no pressure applied to the paper across the width of the space to bond the corrugated paper with the liner.

However, persons skilled in the art will appreciate that the requirements of other materials being rolled may be such that the width of the space between adjacent discs can be greater if desired.

Persons skilled in the art will also appreciate that the configuration of the disc may vary according to their construction. For example, the disc may have a radius approximating a T-shaped profile, with the horizontal member of the T formed the contact surface and the vertical member of the T formed by the disc. The width of the passageway at the contact surfaces of adjacent discs may be less than the width of the passageway between the sides of the discs.

In some embodiments of the present invention, one of the outermost discs may have a solid side, with no passageway formed within the disc. This may help create a more efficient vacuum, as a lesser amount of air is drawn into the vacuum, and thus a greater pressure differential is created at the contact surface of the roller.

In other embodiments of the present invention, a vacuum pump may be provided for each end of the corrugating rollers. This allows smaller vacuum pumps to be used, which saves space and cost.

In some embodiments of the present invention, the discs may also be fabricated with additional apertures or recesses through or on their side faces. This helps reduce the weight of the overall roller, as well as requiring less material for fabrication of the disc.

When used in heated corrugating mechanisms, the aforementioned apertures may be used to pass steam as a heat source for the corrugating mechanism. Heating the rollers may accelerate the bonding of the adhesive between the corrugated and liner layers of paper or cardboard.

The discs may be constructed from any suitable material such as hardened alloy steel.

Paper or cardboard can also be corrugated using cold forming techniques which do not require the heating of rollers. Such techniques do not necessarily require rollers made from heavy steel or steel alloys.

In preferred embodiments of the present invention, the discs are constructed from relatively lightweight materials. For example, the discs may be made from, but not limited to, plastics material, aluminium, fibreglass, resin composites or wood.

Manufacturing discs from these materials offers significant advantages over discs made from conventional steel or hardened alloy steel. Compared to steel or hardened alloy steel, these materials are also easy to work or machine.

The required machinery for working these materials is also relatively inexpensive or easy to source compared to the foundry and heavy machinery required for manufacturing steel or steel alloys.

Another advantage of these materials is that corrugating rollers made from plastics material, aluminium, fibreglass, resin composites or wood are relatively lightweight and easy to handle compared to corrugating rollers in the prior art.

Being constructed from these materials, the corrugating rollers themselves may be fabricated so that they are much larger in diameter than conventional rollers made of hardened alloy steel.

The use of larger diameter rollers may increase output of the corrugating mechanism, which is beneficial for the owner of the machine as production is increased.

Another embodiment of the present invention has the discs primarily made from thin steel centre with removable gear sectors attached. This allows for interchangeability of parts ensuring that a whole disc does not need to be replaced if a tooth breaks.

In preferred embodiments the gear sector is made from plastics material, but this should not be seen as limiting.

The roller may be configured such that it can fit onto an axle. In preferred embodiments of the present invention, the discs are provided with an aperture at their centre complementary to the diameter of the axle.

The axle should be understood to mean a rotating member to which the roller is mounted to allow rotation of the roller in the same direction as the rotation of the axle.

The axle may be constructed from any suitable material sufficient to withstand the weight and pressures of the roller, such as a metal alloy.

The axle may be provided with a driving means to facilitate rotation of the axle. The driving means may be a small motor or generator.

Preferably, the driving means is an electric motor, which may be single phase or three phase, with the capacity of the motor dependent on the size and weight of the corrugating roller.

In preferred embodiments of the present invention, the axle may be provided with a ridge (or key) running lengthwise along the axle. The ridge may be complementary to a notch provided about the central aperture of the corrugating roller. This locks the roller in place with respect to the axle to prevent slippage. Other methods of locking the corrugating rollers will be readily apparent to persons skilled in the art.

When the preferred embodiment of the present invention is in use, a vacuum is created in the passageway through a disc or discs which is translated to the space between adjacent discs. The air is drawn into the vacuum pump from the contact surface via the disc spaces and passageway.

The resulting pressure differential draws the sheet of paper or cardboard being corrugated towards the contact surface of the discs forming the roller.

As the corrugating discs turn, the paper or cardboard passes between the discs and a pressure member.

The pressure member, which may be an opposing corrugating roller, applies force to the paper or cardboard being formed. If the paper or cardboard is not maintained in position across the contact surface of the corrugating rollers, inconsistent corrugations can result.

Drawing the paper or cardboard close to the corrugating rollers so that it is held in position across the corrugating rollers increases the overall efficiency of the corrugating mechanism.

The paper or cardboard does not slacken or fall away from the rollers. The corrugations that are formed are more consistent and evenly spaced, resulting in a higher quality product.

Persons skilled in the art will appreciate that the passageways of the present invention may have other applications depending the material being rolled. For example, the passageway and spacings may provide a conduit for steam, gases or vaporized liquids such as disinfectants, pesticides, herbicides, adhesives or sprays.

The present invention offers a number of advantages over the prior art:
Constructing composite rollers from a plurality of discs or single rollers allows the creation of a pressure differential between the contact surface of the rollers and the side of the rollers. Because of the proximity of the vacuum source (via a passageway), a more efficient vacuum is able to be created. This increases the effectiveness of the corrugating rollers by ensuring the material being corrugated is held in position as it passes through the rollers.
Reduces manufacturing costs of the corrugating rollers. The material from which the rollers may be fabricated is relatively inexpensive to source and to work.
Constructing the composite rollers from a plurality of discs simplifies the replacement and maintenance of the rolling mechanism. Replacement costs are reduced, as in the event of damage or wear to one of the discs, only a single disc needs to be replaced.
Corrugating rollers may be made with a larger diameter which may increase the period of time which the paper is on the roller, thus increasing the bonding time available for bonding the liner to the corrugated paper.
Larger diameter rollers may result in less stress on the material being corrugated.
Using lightweight materials for constructing the corrugating rollers allows the use of smaller electric motors, which consume less energy.
Productivity is increased. The corrugating rollers of the present invention, being manufactured from relatively lightweight materials, are able to be of a larger diameter than is possible in prior art systems. Because of the larger diameter rollers, more product can be passed through the machine.
Maintenance of the corrugated rollers is more much easily achieved.

### BRIEF DESCRIPTION OF DRAWINGS

Further aspects of the present invention will become apparent from the following description which is given by way of example only and with reference to the accompanying drawings in which:

FIG. 1 shows a schematic side elevation of a single face machine which incorporates a roller in accordance with one possible use of the present invention;

FIG. 2 shows a front view of the present invention, showing a plurality of corrugating rollers;

FIG. 3 shows a side view of the present invention;

FIG. 4 shows a perspective view of the present invention, showing a plurality of corrugating rollers;

FIG. 5 shows a perspective view of a corrugating roller in accordance with one embodiment of the present invention, and

FIG. 6 shows an end view of a disk within the corrugating roller shown in FIGS. 5, and

FIG. 7 shows a gear sector which forms part of the disk shown in FIG. 6.

### BEST MODES FOR CARRYING OUT THE INVENTION

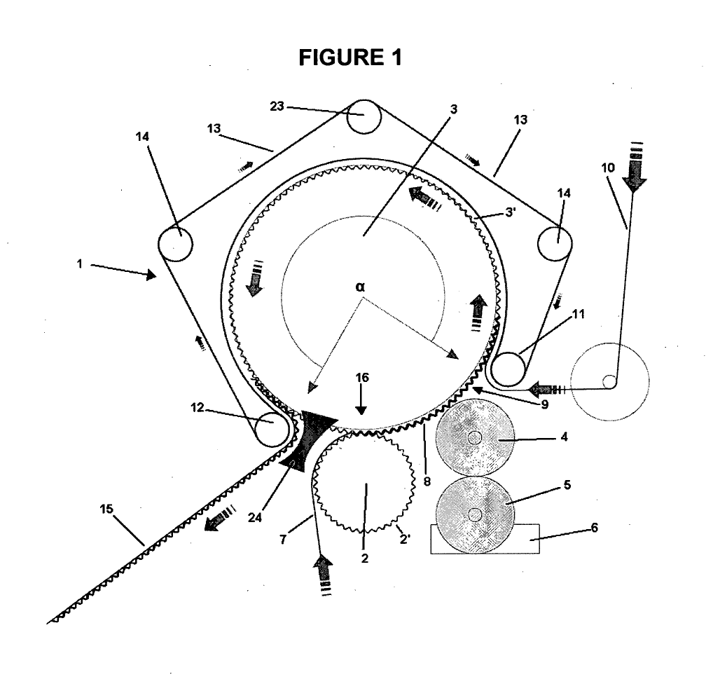

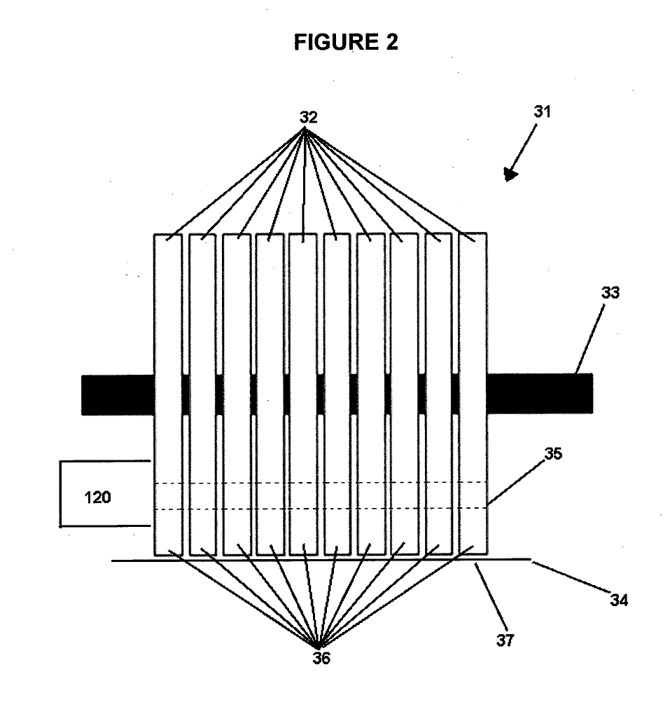

FIG. 1 illustrates how the present invention can be used in a corrugating machine and a generalised description of its operation thereof is given below. FIGS. 2 to 7 illustrates specific embodiments of a roller and roller parts in accordance with the present invention.

A portion of a machine for forming single faced corrugated board is generally shown by arrow (1) in the schematic side elevation shown in FIG. 1.

A first corrugating roll (2) has teeth (2′) arranged around the periphery of the first corrugating roll (2), the teeth (2′) extending laterally across the width of the first corrugating roll (2).

A second corrugating roll (3) has teeth (3′) around its periphery. The diameter of the second corrugating roll (3) is substantially larger than the diameter of the first corrugating roll (2).

The corrugating rolls (2 and 3) are arranged such that teeth (2′) of the first corrugating roll (2) intermesh with the teeth (3′) of the second corrugating roll (3) in the region indicated by arrow (16).

The first corrugating roll (2) is powered to rotate in a clockwise direction and the second corrugating roll (3) is powered to rotate in an anticlockwise direction, as indicated by the dashed arrows.

A planar sheet material, in the form of a sheet of Kraft paper (7), is fed around the first corrugating roll (2) and between the intermeshed teeth in the region of arrow (16). The action of the teeth as they intermesh folds the Kraft paper into a series of crests to form a fluted sheet (8).

The second corrugating roll (3) includes open passageways (illustrated in FIGS. 2 to 4 discussed below) so that a partial vacuum can be created inside the corrugating roll (3) by connecting a vacuum pump (120) to one end of the corrugating roll (3). This partial vacuum inside the second corrugating roll (3) is used to hold the fluted sheet (8) in place against the teeth (3′) of the second corrugating roll (3).

A glue roller (4) is rotatably mounted alongside the second corrugating roll (3), the axis of rotation of the glue roller (4) being substantially parallel to the axis of rotation of the corrugating roll (3).

A pick-up roller (5) is rotatably mounted on an axis substantially parallel to the axis of the glue roller (4), and is arranged such that the surface of the pick-up roller (5) makes firm contact with the glue roller (4).

A bath (6) contains adhesive in the form of Adhesin™ Z9129W. The bath (6) is arranged such that the outer surface of the pick-up roller (5) is coated with Adhesin™ Z9129W as the pick-up roller (5) rotates.

Both the glue roller (4) and pick-up roller (5) have a width comparable to the width of the fluted sheet (8).

A second planar sheet of Kraft paper, in the form of a liner (10) is pressed against the fluted sheet (8) by a first guide end roller (11) via an endless belt (13).

The endless belt (13) is held in place against the periphery of the second corrugating roll by the action of the first guide end roller (11), second guide end roller (12), two guide rollers (14) and a tensioning roller (23).

The separation of the first guide end roller (11) from the second guide end roller (12) determines the length over which the endless belt (13) applies pressure to the liner (10). This separation corresponds approximately to three quarters of the periphery of the second corrugating roll (3), this being approximately the maximum length available (so as to leave room for the first corrugating roll (2) and the applicator (4).

Tension is applied to the endless belt (13) by adjusting radially (with respect to the axis of the second corrugating roll (3)) the position of the tensioning roller (23).

In practice tension in the belt is adjusted to the point where damage, typically in the form of creasing or tearing of the liner and/or fluted paper, occurs. The tension, is then adjusted downwards by backing off the tensioning roller (23) to a tension where damage does not occur. The amount of tension applied depends on many factors including the nature of the sheet materials used for the liner and fluted sheets.

A pick (24) is used to help release the bonded single face corrugated board (15) from being held by the vacuum inside the second corrugating roll (3).

The rate of production of single face corrugated board (15) in this arrangement is determined by the diameter and rotation speed of the second corrugating roll (3). With the endless belt (13) extending around approximately three quarters of the periphery of the second corrugating roll (3), this fixes the rotation time at around 20 revolutions per minute, independent of the diameter of the roll (3). However, the amount produced is dependent on the diameter, D (measured in metres), of the roll (3) and is given (for the configuration described above) by 20πD metres per minute, i.e., around 63 times the diameter of roll (3) (measured in metres) metres per minute.

For example, a second corrugating roller (3) having a diameter of 1.6 m may produce around 100 m/min of single face paper board.

A top view of the second corrugating roller (3) in FIG. 1, in accordance with one embodiment of the present invention, is illustrated in FIG. 2. The second corrugating roller (now generally indicated by arrow 31) consists of a plurality of discs (32) mounted to an axle (33).

In use, paper or cardboard (34) is passed in between the corrugated contact surface on the periphery of the discs (32) and a pressure member (not shown).

To ensure that the paper (34) is held in contact with the corrugated surface of discs (32) a vacuum is applied to the corrugating roller (31) through the passageway (indicated by dashed lines 35) via a vacuum source (120).

The spaces (36) between adjacent discs (32) allows the creation of a vacuum at the contact surface of the roller (37). This vacuum urges the paper (34) towards the axle (33) so that it is tightly pressed against the corrugating rollers (32).

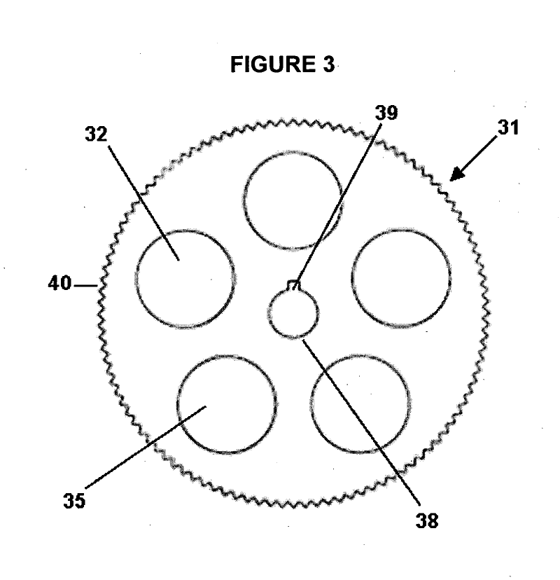

Turning now to FIG. 3, a side view of one of the discs (32) of the corrugating roller (31) is depicted. In this view, the aperture (38) provided in the centre of the disc (32) for the axle (not shown) is visible. A notch (39) which engages a nub on the axle is provided to ensure that there is no slippage of the disc (32) around the axle (not shown).

Also visible in this view is the passageway (35) arranged through the side of the disc (32). These passageways (35) also contribute to the reduction in weight of the corrugating rollers (32).

Around the circumference of the disc (32) are the corrugating teeth (40).

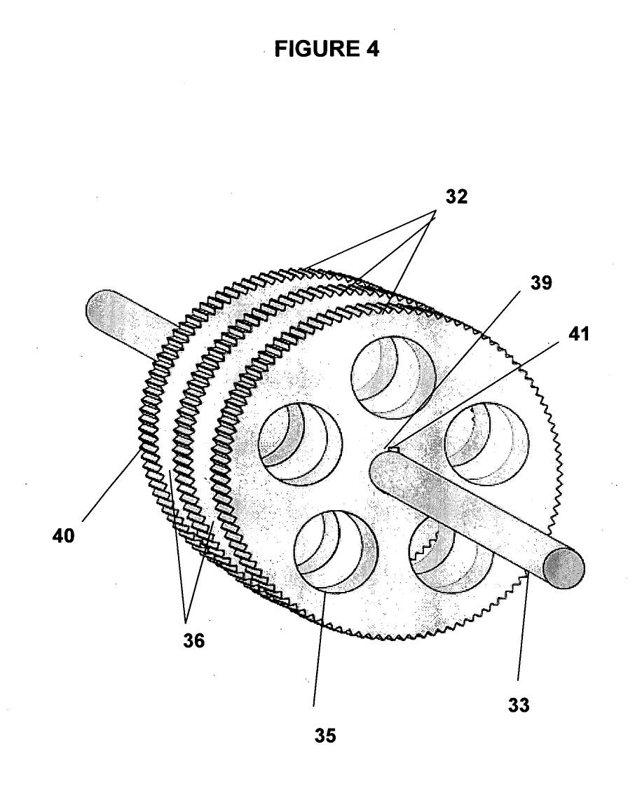

An exploded perspective view (with the discs (32) spaced apart) of the present invention is illustrated in FIG. 4. The discs (32) are mounted to the axle (33). The axle (33) is provided with a nub (41) which engages with the notch (39) of the disc (32).

Between each successive disc (32), a passageway (36) leading to the passageways (35) of the disc (32) is provided in which a vacuum is formed. This holds the paper (not shown) against the corrugating teeth (40) of the discs (32).

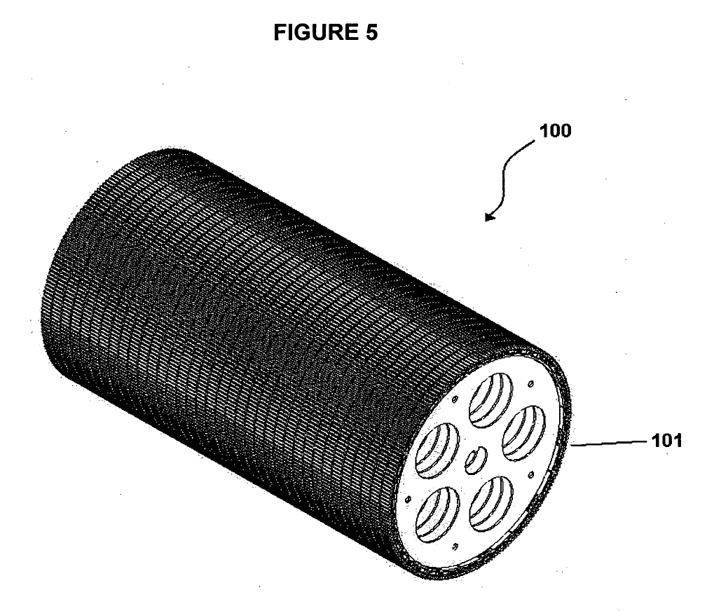

The discs depicted (32) show the passageways (36) on their sides. In some embodiments of the present invention, the outermost corrugating roller (40) may be formed without this passageway (36). An alternate embodiment of the present invention is shown in FIGS. 5, 6 and 7.

FIG. 5 illustrates a corrugating roller generally indicated by arrow (100) having a number of individual discs (101).

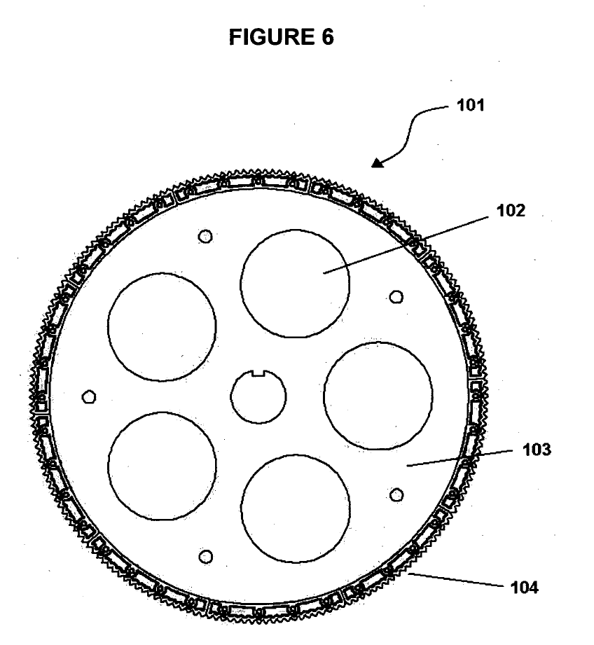

FIG. 6 illustrates an individual disc generally indicated by arrow (101).

As can be seen, the disc (101) has the passageways (102) as described with regard to previous embodiments of the present invention.

However, where the disc (101) varies from the disc (32) is that it is comprised of substantially two parts.

The disc (101) is made from a central disc portion (103) which has been constructed from thin steel and a peripheral portion (104) around the circumference of the thin disc (103). The peripheral portion (104) is made up of a number of gear sectors (104).

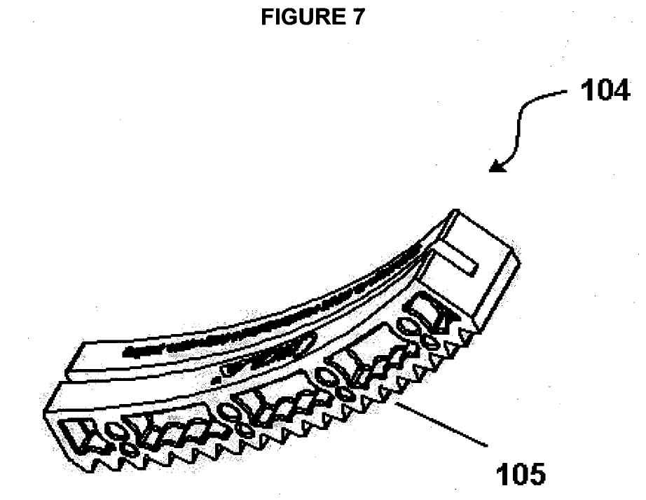

The construction of a gear sector (104) is shown more clearly in FIG. 7.

The sectors (104) are made from plastics material and have corrugating teeth (105) similar to those teeth (40) illustrated in FIG. 3.

Aspects of the present invention have been described by way of example only and it should be appreciated that modifications and additions may be made thereto without departing from the scope of the appended claims.

1.-25. (canceled)

26. A corrugating roller constructed for use in an non-heated process, the corrugating roller configured with a corrugated contact surface about an outer face of the roller, wherein the roller includes a passageway between the opposing sides, and the passageway is configured as a conduit for ambient temperature air under the influence of a vacuum source to flow from the contact surface of the roller to the passageway through the roller, wherein the roller is substantially fabricated from materials having a lesser density than steel.

27. A corrugating roller as claimed in claim 26 which is formed from a plurality of similar discs mounted on an axle.

28. A corrugating roller as claimed in claim 27 wherein the discs are assembled on the axle to provide a continuous passageway through the roller.

29. A corrugating roller as claimed in claim 26 wherein there is provided at least one space between adjacent discs to allow fluid flow from around the contact surface of the disc to the passageway through the rollers.

30. A corrugating roller as claimed in claim 29 wherein the space is provided by spacers positioned between the rollers.

31. A corrugating machine including a roller as claimed in claim 26.

32. A corrugating machine as claimed in claim 31 wherein there is provided a vacuum source positioned on one of the outside faces of the roller.

33. A method of corrugating a planar sheet of material using a roller as claimed in claim 26 comprising the steps of:
a) connecting a vacuum source to the end of the passageway(s) at the side(s) of the roller; and
b) passing a planar sheet of material onto the contact surface of the roller;
wherein the vacuum source creates a pressure differential at the contact surface which maintains the material against the roller as a consequence of air at ambient temperature flowing from the contact surface of the roller.

34. A method as claimed in claim 33 wherein the roller includes a plurality of spaced apart discs and the vacuum source causes fluid to flow from the contact surface of the discs to the passageway through the rollers.

35. A machine for producing corrugated material configured to operate a roller in accordance with the method as claimed in either claim 33 or claim 34.

36. A machine as claimed in claim 35 wherein the machine includes a pressure member configured to apply force to the corrugated material being formed on the roller.

37. A Corrugated material made from a machine as claimed in claim 31.

38. A Corrugated material made from a machine as claimed in claim 35.

39. A corrugated material produced in accordance with the method as claimed in either claim 33 or claim 34.

40. A gear sector configured to form at least part of the corrugated contact surface of the roller as claimed in claim 26.
